(19) United States
(12) Patent Application Publication
(10) Pub. No.: US 2010/0232654 A1
(43) Pub. Date: Sep. 16, 2010

(54) METHOD FOR RECONSTRUCTING IRIS SCANS THROUGH NOVEL INPAINTING TECHNIQUES AND MOSAICING OF PARTIAL COLLECTIONS

(75) Inventors: Mark Rahmes, Melbourne, FL (US); Josef Allen, Melbourne, FL (US); Patrick Kelley, Palm Bay, FL (US); C.W. Sinjin Smith, Palm Bay, FL (US)

Correspondence Address: HARRIS CORPORATION;C/O FOX ROTHSCHILD, LLP, 997 Lenox Drive, Building 3, Lawrenceville, NJ, 08543-5231, US

(73) Assignee: Harris Corporation, Melbourne, FL (US)

(21) Appl. No.: 12/401,858

(22) Filed: Mar. 11, 2009

(51) Int. Cl. G06K 9/00

(52) U.S. Cl. 382/117

(57) ABSTRACT

A method and system for reconstructing iris scans for iris recognition is provided. A plurality of iris collection images of an iris is received. A single iris image of the iris is reconstructed using at least two of the plurality of iris collection images. Mosaicing may be used to combine at least two of the plurality of iris collection images into a single iris image. Inpainting methods, including PDE-based and exemplar-based techniques, may also be used to fill in area of missing information in an iris image.

### BACKGROUND OF THE INVENTION

1. Statement of the Technical Field

The inventive arrangements relate to biometric systems, and more particularly to iris scan reconstruction using novel inpainting techniques and mosaicing of partial iris collection images.

2. Description of the Related Art

Biometric systems are used to identify individuals based on their unique traits. Biometrics are useful in many applications, including security and forensics. Some physical biometric markers include facial features, fingerprints, hand geometry, and iris and retinal scans. A biometric system can authenticate a user or determine the identity of sampled data by querying provide a database.

There are many advantages to using biometric systems. Most biometric markers are present in most individuals, unique between individuals, permanent throughout the lifespan of an individual, and easily collectable. However, these factors are not guaranteed. For example, surgical alterations may be used to change a biometric feature such that it does not match one previously collected from the same individual. Furthermore, different biometric features can change over time.

Iris scans are considered a non-invasive, robust form of biometric identification when the scan is performed under optimal conditions. Each iris has a unique iris pattern which forms randomly during embryonic development. An iris pattern is stable over an individual's lifetime. The features of an iris include the stroma, the sphincter of a pupil, and the anterior border layer, including the crypts fuchs, papillary ruff, circular contraction folds and crypts at the base of the iris. Iris recognition uses camera technology to create images of the detailed and intricate structures of the iris. Iris scans are rarely affected by corrective eyewear, such as glasses or contact lenses.

Iris scans may be used in one-to-many identifications or in one-to-one verifications. Verification systems confirm or deny the claimed identify of an individual. Identification systems the identify of an individual is determined by comparing a biometric reading to a database of stored biometric data.

Once constructed, many methods exist for the analysis of iris scans. Typically, an analysis algorithm will identify the approximately concentric outer boundaries of the pupil and the iris in a captured image. The portion of the image consisting of the iris is then processed, creating a digital representation which preserves the information essential for identification purposes. Iris identification systems must deal with practical problems which may interfere with even a good iris scan. For example, eyelids and eyelashes must be excluded from the processed iris representation. Furthermore, the spherical nature of the eye may cause specular reflections which need to be predicted and accounted for.

Despite the usefulness of iris scans to identify individuals, the technology has limitations. In particular, the collection of quality iris scans suitable for iris recognition limits its application. Collecting quality iris scans is difficult to perform at a distance. The cooperation of the subject in looking at the camera highly affects the quality of the iris scan. Iris scans are a touch-less capture and interrogation technology. They are typically taken from a cooperative subject, but can also be collected covertly, such as in an airport. These iris scans may be of considerably lower quality, resolution and information content. In addition, these iris scans may be acquired off-axis with respect to the camera. Some lighting conditions may exacerbate glare caused by the reflective surface of the cornea, obstructing details used in iris analysis. Furthermore, some iris recognition systems can be bypassed by presenting a high-resolution photograph of a face. It is desirable to increase the range of conditions under which iris scans can provide quality biometric identification, enabling usage in adverse situations where reliable iris identification was not previously feasible.

### SUMMARY OF THE INVENTION

The invention concerns a method and system for reconstructing iris scans for iris recognition. A plurality of iris collection images of an iris is received. A single iris image of the iris is reconstructed using at least two of the plurality of iris collection images. The iris collection images may be overlapping partial images of the iris.

According to another aspect of the invention, reconstructing a single iris image of the iris further comprises mosaicing at least two of the plurality of iris collection images into a single iris image. Mosaicing may be performed using at least one structural feature of the iris. The at least one structure feature of the iris may be selected from the group consisting of a structure of a pupil, a stroma, a sphincter, a crypts fuchs, a papillary ruff, a circular contraction fold, and crypts at the base of the iris. At least two iris collection images are registered. The registered images may be blended based on an overlapping structural features of the iris.

According to another aspect of the invention, reconstructing a single iris image of the iris further comprises identifying at least one area of missing information in at least one iris collection image and using inpainting techniques to fill in at least one identified area of missing information. Areas of missing information may include areas occluded by specular reflection, a single eyelash, multiple eyelashes, dust, image noise, lighting, and uncaptured areas.

According to another aspect of the invention, an area of missing information is filled using an exemplar-based inpainting technique. An incomplete region is determined, the incomplete area containing an area of missing information. Candidate patching regions are determined for the incomplete region in the plurality of iris collection images. A candidate patching region may be selected which maximizes global visual coherence between the incomplete region and the candidate patching region. Global visual coherence is determined by comparing a distance between a plurality of local-space patches in the candidate patching region and corresponding local-space patches in the incomplete region. The selected candidate patching region is used to fill in the area of missing information and complete the incomplete region.

According to another aspect of the invention, an area of missing information is filled using a partial differential equation (PDE)-based inpainting technique. The PDE-based inpainting technique may include a curvature driven diffusion approach.

According to another aspect of the invention, an inpainting technique used to fill in an area of missing information is automatically determined based on at least one of a size of the area of missing information, an expected data frequency of the area of missing information, and an availability of exemplar fill candidates. An inpainting technique used to fill in an area of missing information may be automatically determined based on all of the size of the area of missing information, the expected data frequency of the area of missing information, and the availability of exemplar fill candidates.

According to another aspect of the invention, a method for iris recognition is provided. A plurality of iris collection images of an iris is received. A single iris image of the iris is reconstructed using at least two of the plurality of iris collection images. Identification data is extracted from the single iris image. The extracted identification data is compared with stored iris data to search for a match. The extracted identification data may be an iris code.

According to another aspect of the invention, reconstructing a single iris image may comprise mosaicing at least two iris collection images. Reconstructing a single iris image may also comprise using inpainting techniques to fill in at least one identified area of missing information. Areas of missing information may be selectively filled using exemplar-based inpainting techniques based on at least one of a size of the area of missing information, a data frequency of the area of missing information, and an availability of exemplar fill candidates. Areas of missing information may be selectively filled using PDE-based inpainting techniques based on at least one of a size of the area of missing information, a data frequency of the area of missing information, and an availability of exemplar fill candidates. An inpainting technique may be automatically selected based on at least one of a size of the area of missing information, a data frequency of the area of missing information, and an availability of exemplar fill candidates.

According to another aspect of the invention, a system for iris recognition comprises a receiving element, a processing element, a storage element, and a matching element. The receiving element receives a plurality of iris collection images of an iris. The processing element reconstructs a single iris image of the iris using at least two of the plurality of iris collection images. The storage element stores a database comprising stored iris data. The matching element determines a match between the single iris image and the stored iris data.

According to another aspect of the invention, the system further comprises at least one imaging element for capturing iris collection images. At least one imaging element may be located to covertly collect said iris collection images. Multiple imaging elements may be strategically placed such that the iris collection images are partial iris collection images, the partial iris collection images overlap, and the partial iris collection images capture the entire iris.

### BRIEF DESCRIPTION OF THE DRAWINGS

FIG. 1 is a block diagram of a computer system that may be used in embodiments of the invention.

FIG. 2 is a flowchart of a method for reconstructing iris scans according to embodiments of the invention.

FIG. 3 is a flowchart of mosaicing as implemented for reconstructing iris scans in embodiments of the invention.

FIG. 4 is a flowchart of inpainting as implemented for reconstructing iris scans in embodiments of the invention.

FIG. 5 is a flowchart of a method for iris recognition according to embodiments of the invention.

FIG. 6 is a block diagram of a biometric identification system according to embodiments of the invention.

### DETAILED DESCRIPTION OF THE PREFERRED EMBODIMENTS

The invention will now be described more fully hereinafter with reference to accompanying drawings, in which illustrative embodiments of the invention are shown. This invention, may however, be embodied in many different forms and should not be construed as limited to the embodiments set forth herein. Accordingly, the present invention can take the form as an entirely hardware embodiment, an entirely software embodiment, or a hardware/software embodiment.

The present invention can be realized in one computer system. Alternatively, the present invention can be realized in several interconnected computer systems. Any kind of computer system or other apparatus adapted for carrying out the methods described herein is suited. A typical combination of hardware and software can be a general-purpose computer system. The general-purpose computer system can have a computer program that can control the computer system such that it carries out the methods described herein.

The present invention can take the form of a computer program product on a computer-usable storage medium (for example, a hard disk or a CD-ROM). The computer-usable storage medium can have computer-usable program code embodied in the medium. The term computer program product, as used herein, refers to a device comprised of all the features enabling the implementation of the methods described herein. Computer program, software application, computer software routine, and/or other variants of these terms, in the present context, mean any expression, in any language, code, or notation, of a set of instructions intended to cause a system having an information processing capability to perform a particular function either directly or after either or both of the following: a) conversion to another language, code, or notation; or b) reproduction in a different material form.

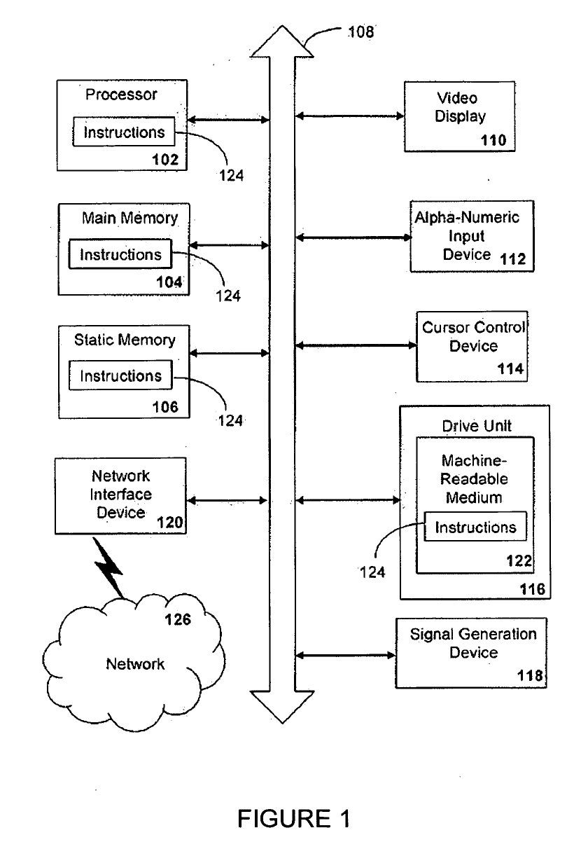

The computer system 100 of FIG. 1 can comprise various types of computing systems and devices, including a server computer, a client user computer, a personal computer (PC), a tablet PC, a laptop computer, a desktop computer, a control system, a network router, switch or bridge, or any other device capable of executing a set of instructions (sequential or otherwise) that specifies actions to be taken by that device. It is to be understood that a device of the present disclosure also includes any electronic device that provides voice, video or data communication. Further, while a single computer is illustrated, the phrase “computer system” shall be understood to include any collection of computing devices that individually or jointly execute a set (or multiple sets) of instructions to perform any one or more of the methodologies discussed herein.

The computer system 100 can include a processor 102 (such as a central processing unit (CPU), a graphics processing unit (GPU, or both), a main memory 104 and a static memory 106, which communicate with each other via a bus 108. The computer system 100 can further include a display unit 110, such as a video display (e.g., a liquid crystal display or LCD), a flat panel, a solid state display, or a cathode ray tube (CRT). The computer system 100 can include an input device 112 (e.g., a keyboard), a cursor control device 114 (e.g., a mouse), a disk drive unit 116, a signal generation device 118 (e.g., a speaker or remote control) and a network interface device 120.

The disk drive unit 116 can include a computer-readable storage medium 122 on which is stored one or more sets of instructions 124 (e.g., software code) configured to implement one or more of the methodologies, procedures, or functions described herein. The instructions 124 can also reside, completely or at least partially, within the main memory 104, the static memory 106, and/or within the processor 102 during execution thereof by the computer system 100. The main memory 104 and the processor 102 also can constitute machine-readable media.

Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present invention, the methods described below can be stored as software programs in a computer-readable storage medium and can be configured for running on a computer processor. Furthermore, software implementations can include, but are not limited to, distributed processing, component/object distributed processing, parallel processing, virtual machine processing, which can also be constructed to implement the methods described herein.

In the various embodiments of the present invention, a computer-readable storage medium containing instructions 124 or that receives and executes instructions 124 from a propagated signal so that a device connected to a network environment 126 can send or receive voice and/or video data, and that can communicate over the network 126 using the instructions 124. The instructions 124 can further be transmitted or received over a network 126 via the network interface device 120.

While the computer-readable storage medium 122 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical medium such as a disk or tape; as well as carrier wave signals such as a signal embodying computer instructions in a transmission medium; and/or a digital file attachment to e-mail or other self-contained information archive or set of archives considered to be a distribution medium equivalent to a tangible storage medium. Accordingly, the disclosure is considered to include any one or more of a computer-readable medium or a distribution medium, as listed herein and to include recognized equivalents and successor media, in which the software implementations herein are stored.

Those skilled in the art will appreciate that the computer system architecture illustrated in FIG. 1 is one possible example of a computer system. However, the invention is not limited in this regard and any other suitable computer system architecture can also be used without limitation.

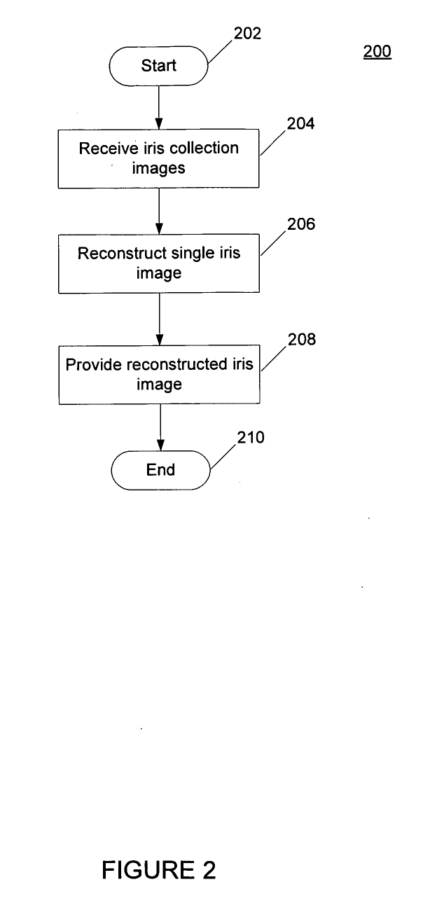

Embodiments of the invention relate to methods for reconstructing iris scans. The reconstructed iris scans may be used for iris recognition. FIG. 2 is a flowchart useful for understanding reconstructing iris scans according to embodiments of the invention. Process 200 begins at step 202 and continues with step 204. In step 204, a plurality of iris collection images is received. As used herein, the term “iris collection image” refers to images which contain at least a partial image of the iris. In one embodiment of the invention, the plurality of iris collection images comprise overlapping partial images of the iris. Preferably, the overlapping partial images capture the entire iris. In one embodiment of the invention, overlapping partial images are purposefully taken to reduce the bandwidth required to transmit images of portions of an iris without reducing image resolution. The iris collection images may be received in real time as the images are taken. Alternatively, the iris collection images received may be images taken at an earlier time. The iris collection images may be taken in a digital form or may be converted to digital form by scanning or any other means.

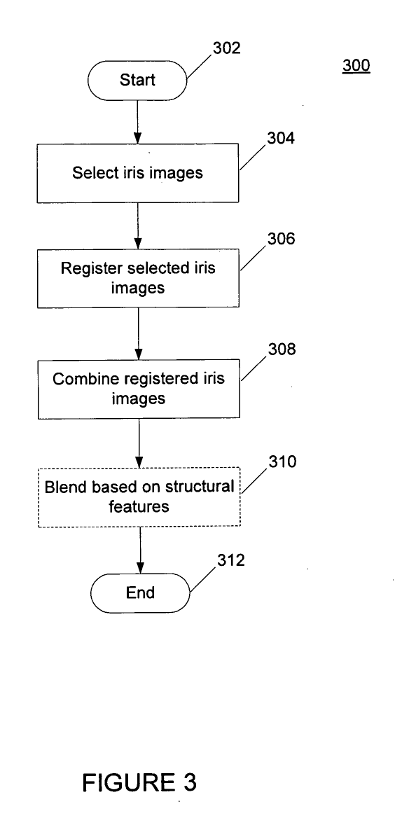

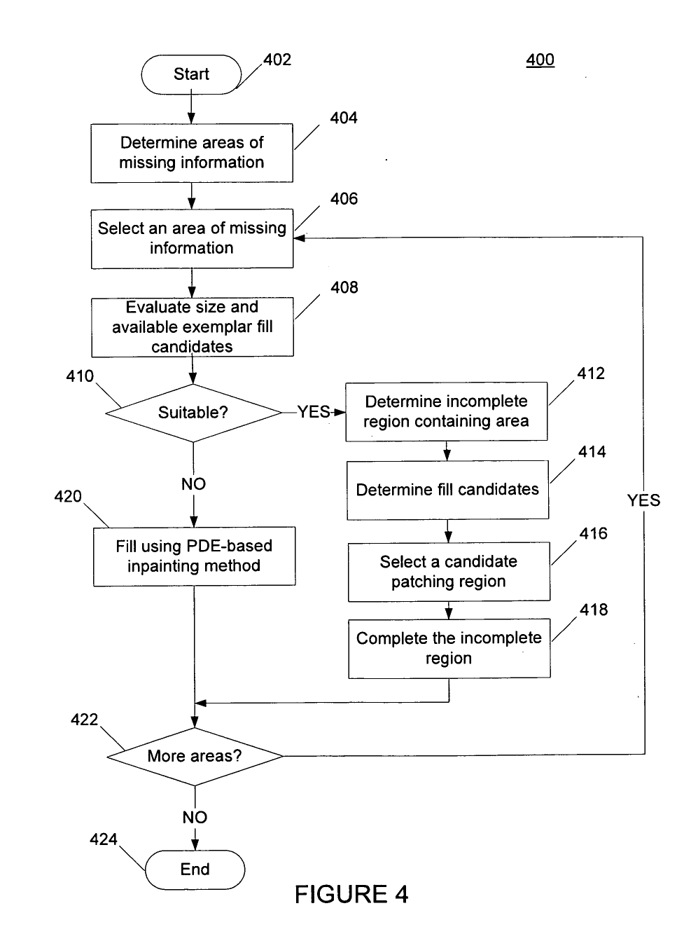

The process continues to step 206, where a single iris image is reconstructed using at least two of the plurality of iris collection images. Reconstructing may comprise mosaicing at least two of the plurality of iris collection images. Mosaicing in one embodiment of the invention is described in detail in FIG. 3. Reconstructing may also comprise using inpainting techniques to fill in at least one area of missing information in an iris image. As used herein, the term “inpainting” refers to any method for filling in a part of an image or video using information from the surrounding area and/or similar images or photos. Inpainting in one embodiment of the invention is described in detail in FIG. 4. In a preferred embodiment of the invention, both mosaicing and inpainting techniques are used to reconstruct an iris scan using at least two of the plurality of iris collection images.

The process continues to step 208, where the single iris image is provided. Preferably, the single iris image contains more information than any individual one of the plurality of iris collection images. The single iris image may be provided to a system which extracts identification information useful for verification, identification, or for storage as iris data associated with the individual from whom the iris collection images were taken. In step 210, the process terminates.

FIG. 3 is a flowchart useful for understanding mosaicing iris collection images according to embodiments of the invention. Process 300 begins at step 302 and continues with step 304. In step 304, at least two iris collection images are selected from the plurality of iris images for mosaicing. The images may be selected based on coverage of the complete iris by the images, amount of overlap, image quality, or any other characteristic that makes the selected images suitable for reconstruction of an iris scan.

The process continues to step 306, where the selected iris collection images are registered. Methods for image registration are known in the art. In one embodiment of the invention, the images may be registered pairwise, in an order which may be determined based on coverage, overlap, image quality, or any other characteristic that is useful for determining an order.

The process continues to step 308, where the registered iris collection images are combined. The at least two iris collection images may be registered and combined in one step or through iterative steps, where an image is added and combined in each iteration. The iris collection images may be combined using rotations, translations, and other information created during registration step 306.

The process continues to optional step 310, where the combined iris images are blended using at least one structural feature of the iris, such as the pupil, the stroma, the sphincter, the crypts fuchs, the papillary ruff, the circular contraction fold, and the crypts at the base of the iris. Blending may take place at overlapping regions of the registered iris collection images. Knowledge of the general properties of such structural features may be incorporated in blending the registered images to enhance the accuracy of the reconstructed iris image. For example, the registered images may be blended such that an overlapping structural feature in the images is made to conform with known general properties of the structural feature. In one embodiment of the invention, structural features are used to fine-tune the registration and combination of the iris collection images. In step 312, the process terminates.

FIG. 4 is a flowchart useful for understanding reconstructing iris scans according to embodiments of the invention. Process 400 begins at step 402 and continues with step 404. In step 404, at least one area of missing information is identified. The area of missing information may be identified within an iris collection image. The area of missing information may also be identified within an a mosaic of at least two iris collection images. Areas of missing information may include areas occluded by specular reflection, a single eyelash, multiple eyelashes, dust, image noise, lighting, uncaptured areas, and portions of an image which are deemed incomplete for any other reason.

The process continues to step 406, where an area of missing information is selected. At least one inpainting technique is used to fill in the selected area of missing information. For example, inpainting techniques may include partial differential equation (PDE) based inpainting techniques, exemplar-based inpainting techniques, and any other method for reconstructing missing information in an area of missing information.

The process continues to step 408, where the selected area of missing information is evaluated to determine whether filling using an exemplar-based inpainting technique is suitable. In one embodiment of the invention, determining whether an exemplar-based inpainting technique is suitable involves evaluating at least one of the size of the area of missing information, the expected data frequency of the area of missing information, and the availability of exemplar fill candidates. In one embodiment of the invention, a predetermined level of at least one of the size, the expected data frequency, and availability of exemplar fill candidates may be used to automatically determine the inpainting method used to fill an area of missing information. For example, areas of missing information of a size greater than a predetermined size may be filled using an exemplar-based inpainting technique. In another embodiment of the invention, all three of the size of the area of missing information, the expected data frequency of the area of missing information, and the availability of exemplar fill candidates are evaluated to determine the proper inpainting technique to use.

Exemplar-based inpainting techniques are preferred if the area of missing information is larger in size, since the accuracy of PDE-based inpainting techniques decreases when the size of the area of missing information increases. Exemplar-based inpainting techniques are also preferred when the expected data frequency of the area of missing information is high. High data frequency corresponds to the complexity of the structures and texture in an image. Areas rich in detail and texture have a higher data frequency. PDE-based inpainting techniques work best when low data frequency (e.g. smoothness) is expected in the area to be filled. Exemplar-based inpainting techniques are also preferred when exemplar fill candidates are available. Exemplar-based inpainting techniques are more effective when exemplar fill candidates exist that closely match the incomplete region containing the area of missing information. Exemplar fill candidates from images of the same iris are more likely to have similar patterns as those of the area of missing information. Furthermore, exemplar fill candidates from the same region may be found when multiple iris collection images are taken and some iris collection images overlap. In one embodiment of the invention, the inpainting method is chosen automatically based on this evaluation.

In a preferred embodiment of the invention, a dynamic decision making process is used to automatically determine an inpainting method to be used to fill an area of missing information. The dynamic decision making process may evaluate at least one of the size of the area of missing information, the expected data frequency of the area of missing information, the availability of exemplar fill candidates, and any other factor useful for determining a suitable inpainting method. For example, an area of missing information may have a size typical of areas suitable for PDE-based inpainting methods. However, if the expected data frequency of the area is high and many exemplar fill candidates are available, a dynamic decision making process may determine that an exemplar-based inpainting technique is suitable for filling the area of missing information. In one embodiment of the invention, a decision algorithm selectively chooses the inpainting technique used to fill an area of missing information. For example, a decision table comprising rules concerning size, expected data frequency and available exemplar fill candidates may be used to determine an inpainting technique to fill an area of missing information. Alternatively, a weighted function may be used to determine an inpainting technique to fill an area of missing information based on the size, expected data frequency, and available exemplar fill candidates. In embodiments of the invention, the decision algorithms may involve data collected using statistical methods or neural network rule extraction.

The process continues to decision block 410, where it is determined whether an exemplar-based inpainting technique will be used based on evaluation step 408. If exemplar-based inpainting is suitable, the process continues to step 412. Otherwise, the process continues to step 420.

In step 412, an incomplete region which contains the selected area of missing information is determined. In one embodiment of the invention, the incomplete region wholly contains the selected area of missing information. Preferably, the incomplete region contains sufficient areas bordering the selected area of missing information to choose a proper exemplar fill candidate. A local-space patch is a small region around any pixel p in an image. Local-space patches in the incomplete region are used to search for a good exemplar fill candidate for filling the area of missing information by comparing local-space patches of the incomplete region to local-space patches in exemplar fill candidates. In the incomplete region, local-space patches useful for comparing are those which lie outside of the area of missing information.

The process continues to step 414, where candidate patching regions for the incomplete region are determined. Preferably, the candidate patching regions are determined from the iris collection images of the iris, or other images of the same iris.

The process continues to step 416, where one of the candidate patching regions is selected for patching the area of missing information. In one embodiment of the invention, the selection is based on maximizing global visual coherence between the incomplete region and the candidate patching region. Global visual coherence is determined by comparing a distance between a plurality of local-space patches in the candidate patching region and corresponding local-space patches in the incomplete region. An incomplete region M containing an area of missing information has global visual coherence with a region F if all local-space patches in M can be found in F. In one embodiment of the invention, a local-space patch is defined as a small region around any pixel in an image, and a local-space patch exists for each pixel p within the incomplete region, excluding the area of missing information contained in the incomplete region. A local-space patch also exists for each pixel q in a candidate patching region. The area of missing information should be replenished with new data such that the resulting region M* will be in global visual coherence with F. To maximize global visual coherence, a candidate patching region F is selected which maximizes the following objective function: Coherence(M*|F)=Σmax f(Wₚ, W_{q}), where p and q can be any corresponding spatial location in the images. Wₚ and W_{q} represent small local space patches around point p in region M and point q in region F.

$$f ( {W}_{p} , {W}_{q} ) = exp ( \frac{- d ( {W}_{p} , {W}_{q} )}{2 {σ}^{2}} )$$

represents a patch similarity measure, where d=Σ|Wₚ−W_{q}|², ∀(x, y) is the sum of the squared local distance between two local space patches.

The process continues to step 418, where the selected candidate patching region is used to complete the incomplete region by filling in the area of missing information. In one embodiment of the invention, another inpainting technique, such as a PDE-based inpainting technique, may be used to complete the filling of the area of missing information. For example, a PDE-based inpainting technique may be used to enhance the exemplar-based inpainting technique at the border of the area of missing information. The process continues to decision block 422.

Returning to decision block 410, if exemplar-based inpainting techniques are not suitable for filling in the selected area of missing information, the process continues to step 420. In step 420, the selected area of missing information is filled using a PDE-based inpainting technique. In one embodiment of the invention, the PDE-based inpainting technique uses anisotropic diffusion. Anisotropic diffusion is a spatially varying filter that obeys the fundamentals of fluid dynamics. Anisotropic diffusion can be used to mitigate noise while still preserving patterns in an iris. In one embodiment of the invention, a variant of the heat equation is used to propagate information from the boundary of the area of missing information inwards. The analytical equation is of the form:

$$\frac{\partial H}{\partial t} = ( {∇}^{⊥} H ) \cdot ∇ ( Δ H ) + div ( g ( ‖ ∇ H ‖ ) ∇ H )$$

with boundary conditions: H|_{∂Ω}=Hₒ, where Hₒ is the initial image. The rate of change of the Laplacian ΔH is propagated in the direction of minimum change. Coupled with the propagation term is the anisotropic diffusion term: div(g(∥∇H∥)∇H). Anisotropic diffusion is related to the connectivity principle and disocclusion. The connectivity principle is a vision psychology term that describes how the human brain connects disoccluded objects. A fissure or break in an iris pattern can be thought of as a disocclusion. The curvature driven diffusion (CDD) approach modifies a total variational approach to inpainting. The general CDD inpainting model is of the form:

$$\frac{\partial f}{\partial t} = \{ \begin{matrix}∇ \cdot [ \hat{Q} ] ∇ f , & ϛ ∈ D \\ f = {f}_{o} , & ϛ ∈ {D}^{c}\end{matrix} , \hat{Q} = \frac{g ( \vert κ \vert )}{\vert ∇ f \vert} , and κ = ∇ \cdot [ \frac{∇ f}{\vert ∇ f \vert} ] ,$$

where D is the area of missing information, \hat{Q} is extension of the weight equation, \hat{Q}=g(|∇f|). As a result, inpainting becomes coerced in the direction of curvature. The process continues to decision block 422.

At decision block 422, if there are more areas of missing information, the process continues to step 406. Otherwise the process terminates at step 424. Choosing the inpainting method automatically takes advantage of the benefits and differences between PDE-based inpainting and exemplar-based inpainting. In one embodiment of the invention, exemplar-based inpainting techniques are first used to fill in areas of missing information for which exemplar-based inpainting techniques are suitable, based on an evaluation of the size of the area of missing information, the expected frequency of the missing data, and the availability of exemplar fill candidates. Subsequently, PDE-based inpainting techniques are used to fill in the remaining areas of missing information. In another embodiment of the invention, PDE-based inpainting techniques are used on the boundaries of an area of missing information which has already been substantially filled using an exemplar-based inpainting method. In one embodiment of the invention, only a subset of the areas of missing information determined in step 404 are selected for inpainting after evaluation. Factors may be evaluated to determine whether an area of missing information is filled, including the size of the area, the data frequency of the area, the shape of the area, the availability of exemplar fill candidates, the difficulty in filling the area, the expected accuracy, the use of computational resources, or any other relevant factor. Alternatively, the process may attempt to fill all areas of missing information determined in step 404.

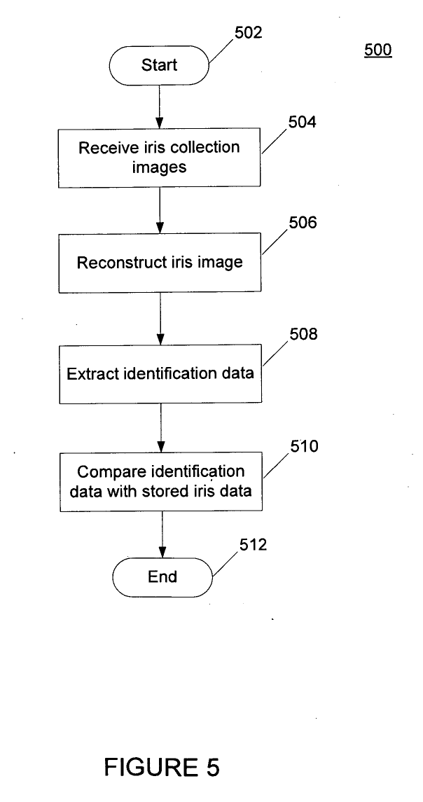

Embodiments of the invention also relate to methods for biometric identification using reconstructed iris scans. FIG. 5 is a flowchart useful for understanding iris recognition according to embodiments of the invention. Iris recognition includes verification of a user's identity, and identification, where the user's identity is determined. Process 500 begins at step 502 and continues with step 504. In step 504, a plurality of iris collection images is received. The iris collection images may be received in real time as the images are taken. Alternatively, the iris collection images received may be images taken at an earlier time.

The process continues to step 506, where a single iris image is reconstructed using at least two of the plurality of iris collection images. In one embodiment of the invention, the reconstructing step comprises mosaicing at least two iris collection images. In another embodiment of the invention, the reconstructing step comprises identifying areas of missing information and using inpainting techniques to fill in at least one area of missing information. Exemplar-based inpainting techniques and/or PDE-based inpainting techniques may be used to fill in an area of missing information. In one embodiment of the invention, the inpainting technique used to fill in an area of missing information is automatically selected based on the size of the area of missing information, the data frequency of the area of missing information, and the availability of exemplar fill candidates. Both inpainting techniques and mosaicing techniques may be used to reconstruct a single iris image using at least two of the plurality of iris collection images.

The process continues to step 508, where identification data is extracted from the single iris image. In one embodiment of the invention, the identification data extracted from the single iris image comprises an iris code. The term “iris code” as used herein refers to a binarized representation of an iris. An iris code may have a real component and an imaginary component. Typically, to generate an iris code, an iris image is mapped to Cartesian coordinates, resulting in an “unrolled” iris image. The iris image may also be processed using a polar coordinate system centered in the middle of the pupil. A filter, such as a Gabor filter, may be applied to the unrolled iris image. When a Gabor filter is used, the result comprises a real and an imaginary part. The results are binarized, reducing the size of the data while retaining important pattern information for identification.

The process continues to step 510, where the extracted identification data is compared with stored iris data to search for a match. In one embodiment of the invention, the iris recognition process is used to verify a user's identity, and the stored iris data comprises iris data previously collected from the user. In another embodiment of the invention, the iris recognition process is used for identification. In this case, identity is determined by comparing the extracted identification data with stored iris data comprising iris data corresponding to a plurality of known individuals. In one embodiment of the invention, the stored iris data is stored in a database associating iris data with known individuals. The stored iris data may be accessible locally, or accessible over a network, such as a wired network, a wireless network, a local area network, or the Internet. In one embodiment of the invention, the stored iris data comprises iris codes of known individuals. The comparison may involve calculating the difference between the extracted iris code and stored iris codes. For example, the difference between the extracted iris code and a stored iris code may be quantified by calculating a Hamming distance. To calculate a Hamming distance between two sets of binary data of the same size, the number of bit positions which differ is divided by the size of the data in bits. Methods for comparing iris codes to search for a match or for verification of a user's identity are known in the art. In step 512, the process terminates.

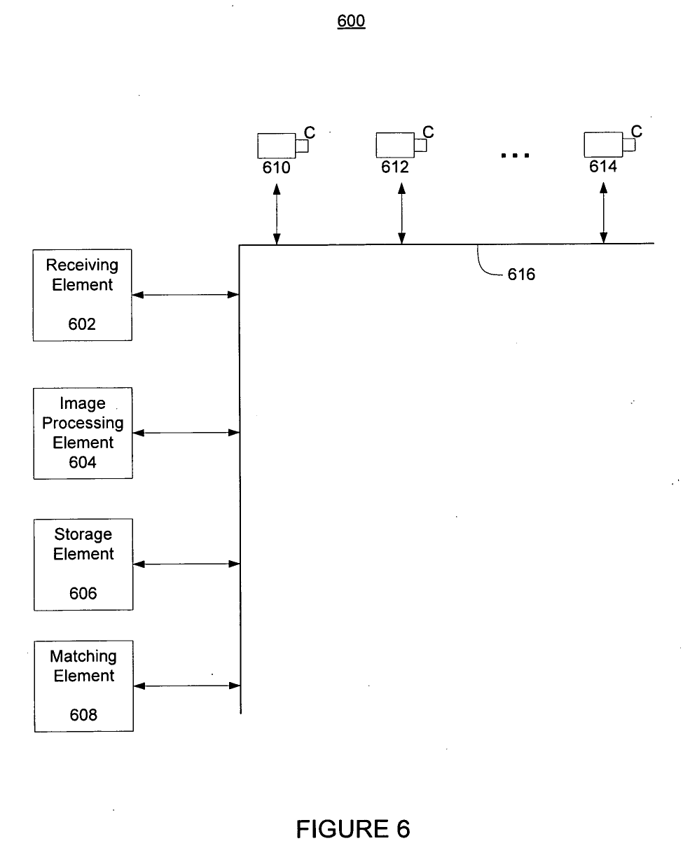

Embodiments of the invention also relate to an identification system according to embodiments of the invention. FIG. 6 is a block diagram useful for understanding a biometric identification system according to embodiments of the invention. System 600 includes receiving element 602, image processing element 604, storage element 606 and matching element 608. Receiving element 602, image processing element 604, storage element 606 and matching element 608 may reside on the same machine or computer system. Alternatively some or all of receiving element 602, image processing element 604, storage element 606 and matching element 608 may reside on different machines or computer systems. Furthermore, some or all of receiving element 602, image processing element 604, storage element 606 and matching element 608 may be implemented in the same computer program.

Receiving element 602, image processing element 604, storage element 606 and matching element 608 communicate via communication channel 616. Communication channel 616 comprises any means of communication, such as direct communication within a machine, direct communication between software processes, or communication over a network or a series of networks, including a wired network, a wireless network, a telecommunications network, a local area network and the Internet.

Receiving element 602 is configured to receive a plurality of iris collection images of an iris. Iris collection images may be received over communication channel 616, including by a direct connection or a wired or wireless network. Receiving element 602 makes the iris collection images available to image processing element 604 via communication channel 616. For example, the iris collection images may be stored on a computer-readable medium accessible to receiving element 602 and image processing element 604. Alternatively, receiving element 602 may provide the iris collection images to image processing element 604 directly or over a wired or wireless network.

Image processing element 604 is configured to reconstruct a single iris image of the iris using at least two of the plurality of iris collection images. In one embodiment of the invention, image processing element 604 mosaics at least two iris collection images. In another embodiment of the invention, image processing element 604 identifies areas of missing information and uses inpainting techniques to fill in at least one area of missing information. Exemplar-based inpainting techniques and/or PDE-based inpainting techniques may be used to fill in an area of missing information. In one embodiment of the invention, the inpainting technique used to fill in an area of missing information is automatically selected based on the size of the area of missing information, the data frequency of the area of missing information, and the availability of exemplar fill candidates. Both inpainting techniques and mosaicing techniques may be used to reconstruct a single iris image using at least two of the plurality of iris collection images. Image processing element 604 makes the single iris image available to matching element 608 by communication channel 616. For example, the single iris image may be stored on a computer-readable medium accessible to image processing element 604 and matching element 608. Alternatively, image processing element 604 may provide the iris collection images to image matching element 608 directly or over a wired or wireless network.

Storage element 606 is configured to store iris data. In one embodiment of the invention, iris data is stored in a database associating iris data with known individuals. For example, the stored iris data may comprise iris codes of known individuals. In one embodiment of the invention, storage element 606 is configured to be capable of adding new iris data to the stored iris data. New iris data may include updated iris data for a known individual, iris data for a second iris of a known individual, or iris data for an individual without any previously stored iris data. Storage element 606 makes the stored iris data available to matching element 608 by communication channel 616. For example, iris data may be stored on a computer-readable medium accessible matching element 608. Alternatively, storage element 606 may provide the iris collection images to image matching element 608 directly or over a wired or wireless network.

Matching element 808 is configured to determine a match between the single iris image and the stored iris data. In one embodiment of the invention, identification data is extracted from the single iris image. Preferably, identification data is extracted in a format that may be compared to the stored iris data provided by storage element 606. In one embodiment of the invention, the identification data extracted from the single iris image comprises an iris code. The extracted identification data is compared with stored iris data from storage element 606 to search for a match. The comparison may involve a calculation of a distance between the extracted iris code and stored iris codes. Methods for comparing iris codes to search for a match are known in the art. In one embodiment of the invention, the iris recognition process is used to verify a user's identity, and the stored iris data comprises iris data previously collected from the user. In another embodiment of the invention, the iris recognition process is used for identification. In this case, identity is determined by comparing the extracted identification data with stored iris data comprising iris data for a plurality of known individuals.

System 600 also optionally includes imaging element 610. System 600 may also optionally include additional imaging elements 612-614. Imaging elements 610-614 are configured to capture iris collection images and provide the captured images to receiving element 602. Imaging elements 610-614 may include both camera and video-recording technologies. Imaging elements 610-614 may communicate with receiving element 602 over communication channel 616. For example, imaging elements 610-614 may be directly connected to receiving element 602, or may communicate over a wired or wireless network.

Imaging elements 610-614 may be configured to covertly collect the iris collection images. As used herein, the term covert collection refers to taking iris collection images of an iris of an individual without the knowledge of the individual. Because reconstructing iris scans results in a better image quality, iris collection images taken in less ideal conditions may be usable, allowing for greater flexibility in the placement of imaging elements 610-614. This enables covert collection in more conditions, including outdoor areas, public areas, and other areas with suboptimal conditions for iris scanning. In one embodiment of the invention, imaging elements 610-614 provide iris collection images to receiving element 602 as they are taken in real time. In another embodiment of the invention, the iris collection images taken using imaging elements 610-614 are provided at a later time. For example, iris collection images taken using imaging elements 610-614 may be stored on a computer-readable medium or a photographic medium, including video media, thus enabling the identification of an individual of interest who has been recorded by imaging elements 610-614 at a previous time.

Imaging elements 610-614 may be strategically placed to maximize the quality of iris collection images. In one embodiment of the invention, imaging elements 610-614 are strategically placed and configured such that the iris collection images are partial iris collection images and the partial iris collection images overlap. In one embodiment of the invention, imaging elements 610-614 are placed such that a flat 2-dimensional photograph presented to the system can be detected as a flat photograph as opposed to an individual's face and iris. Preferably, the iris collection images capture the entire iris. In one embodiment of the invention, a single imaging element 610 is configured to capture multiple partial iris collection images which overlap and capture the entire iris.

All of the systems, methods and algorithms disclosed and claimed herein can be made and executed without undue experimentation in light of the present disclosure. While the invention has been described in terms of preferred embodiments, it will be apparent to those of skill in the art that variations may be applied to the systems, methods and sequence of steps of the methods without departing from the concept, spirit and scope of the invention. More specifically, it will be apparent that certain components and/or steps may be added to, combined with, or substituted for the components and/or steps described herein while the same or similar results would be achieved. All such similar substitutes and modifications apparent to those skilled in the art are deemed to be within the spirit, scope and concept of the invention as defined.

We claim:

1. A method for reconstructing iris scans for iris recognition comprising the steps of:
receiving a plurality of iris collection images of an iris; and
reconstructing a single iris image of the iris using at least two of the plurality of iris collection images.

2. The method of claim 1, wherein the iris collection images are overlapping partial images of the iris.

3. The method of claim 1, wherein said reconstructing step further comprises the step of mosaicing at least two of said plurality of iris collection images into the single iris image.

4. The method of claim 3, wherein mosaicing is performed using at least one structural feature of the iris, said at least one structural feature being selected from the group consisting of a structure of a pupil, a stroma, a sphincter, a crypts fuchs, a papillary ruff, a circular contraction fold, and crypts at the base of the iris.

5. The method of claim 4, wherein said mosaicing comprises:
registration of said at least two iris collection images; and
blending the at least two iris collection images based on a structural feature of the iris.

6. The method of claim 1, wherein said reconstructing step further comprises:
identifying at least one area of missing information in at least one said iris collection images; and
using inpainting techniques to fill in at least one identified area of missing information.

7. The method of claim 6, wherein areas of missing information include areas occluded by specular reflection, a single eyelash, multiple eyelashes, dust, image noise, lighting, and uncaptured areas.

8. The method of claim 6, wherein said area of missing information is filled using an exemplar-based inpainting technique.

9. The method of claim 8, wherein the exemplar-based inpainting technique comprises:
determining an incomplete region of an iris collection image containing an area of missing information; and
determining candidate patching regions for the incomplete region in the plurality of iris collection images.

10. The method of claim 9, wherein the exemplar-based inpainting technique further comprises:
selecting a candidate patching region that maximizes global visual coherence between the incomplete region and the candidate patching region, wherein global visual coherence is determined by comparing a distance between a plurality of local-space patches in the candidate patching region and corresponding local-space patches in the incomplete region; and
using the selected candidate patching region to complete the incomplete region.

11. The method of claim 6, wherein said area of missing information is filled using a partial differential equation (PDE)-based inpainting technique.

12. The method of claim 11, further comprising selecting the PDE-based inpainting technique to include a curvature driven diffusion approach.

13. The method of claim 6, further comprising automatically determining an inpainting technique used to fill in an area of missing information based on at least one of a size of the area of missing information, an expected data frequency of the area of missing information, and an availability of exemplar fill candidates.

14. The method of claim 6, further comprising automatically determining an inpainting technique used to fill in an area of missing information based on the size of the area of missing information, the expected data frequency of the area of missing information, and the availability of exemplar fill candidates.

15. A method for iris recognition comprising:
receiving a plurality of iris collection images of an iris;
reconstructing a single iris image of the iris using at least two of the plurality of iris collection images;
extracting identification data from the single iris image; and
comparing the extracted identification data with stored iris data to search for a match.

16. The method of claim 15, wherein the identification data obtained in said extracting step comprises an iris code.

17. The method of claim 15, wherein said step of reconstructing a single iris image further comprises the step of mosaicing at least two iris collection images.

18. The method of claim 15, wherein said step of reconstructing a single iris image further comprises the steps of:
identifying areas of missing information in the iris collection images; and
using inpainting techniques to fill in at least one area of missing information in at least one of said iris collection images.

19. The method of claim 18, further comprising selectively filling areas of missing information using exemplar-based inpainting techniques based on at least one of a size of the area of missing information, a data frequency of the area of missing information, and an availability of exemplar fill candidates.

20. The method of claim 18, further comprising selectively filling areas of missing information using partial differential equation (PDE) based inpainting techniques based on at least one of a size of the area of missing information, a data frequency of the area of missing information, and an availability of exemplar fill candidates.

21. The method of claim 18, wherein the inpainting technique used is automatically selected based on at least one of a size of the area of missing information, a data frequency of the area of missing information, and an availability of exemplar fill candidates.

22. An iris recognition system, comprising:
a receiving element for receiving a plurality of iris collection images of an iris;
a processing element for reconstructing a single iris image of the iris using at least two of the plurality of iris collection images;
a storage element for storing a database comprising stored iris data; and
a matching element for determining a match between the single iris image and the stored iris data.

23. The system of claim 22, further comprising at least one imaging element for capturing iris collection images.

24. The system of claim 22, wherein the at least one imaging element is located to covertly collect said iris collection images.

25. The system of claim 22, wherein multiple imaging elements are strategically placed such that the iris collection images are partial iris collection images, the partial iris collection images overlap, and the partial iris collection images capture the entire iris.
